(19) United States
(12) Patent Application Publication
(10) Pub. No.: US 2005/0237037 A1
(43) Pub. Date: Oct. 27, 2005

(54) Switching power supply controller system and method

(75) Inventor: Kun Xing, Cary, NC (US)

Correspondence Address: Bryan A. Santarelli;GRAYBEAL JACKSON HALEY LLP, Suite 350, 155 - 108th Avenue NE, Bellevue, WA, 98004-5973, US

(73) Assignee: Intersil Americas Inc.

(21) Appl. No.: 11/087,425

(22) Filed: Mar. 22, 2005

Related U.S. Application Data
(60) Provisional application No. 60/565,058, filed on Apr. 23, 2004.

(51) Int. Cl. G05F 1/40

(52) U.S. Cl. 323/268

(57) ABSTRACT

A regulated output voltage is generated by a switching power supply having a constant voltage-second PWM control signal. During each switching cycle, a control circuit determines the pulse width such that a rapid response and light-load efficiency is provided. This control scheme can maintain accurate output voltage regulation at both light and heavy load conditions with small output voltage ripple. The control circuit also provides a constant switching frequency for a given input voltage and load.

### CLAIM OF PRIORITY

This application claims priority to U.S. Provisional Application Ser. No. 60/565,058, filed on Apr. 23, 2004, which is incorporated by reference.

### BACKGROUND

A switching power supply provides a regulated output voltage, which is often necessary for power management in modern electronic system having either battery power or unregulated power supplies. For battery powered equipment, it is important to extend battery life in a notebook computer or cellular phone when the notebook or phone is in a low-power (e.g., standby, sleep) mode. On the other hand, it is important to provide a well-regulated supply voltage when the notebook or phone is in an operational mode where the power supply is under a significant load. Furthermore, it is important that the switching power supply respond quickly to a change in the load condition, such when the notebook or phone changes from a lower- to a higher-power mode.

Generally, a switching power supply provides a regulated output voltage by controlling the turn-on and turn-off of one or more power switches in a switching stage. The switched voltage is connected to a filter stage to smooth the pulsating voltage. A feedback controller compares the output voltage with a predetermined reference voltage and provides a control signal, which controls the power switches through one or more control-logic circuits. More specifically, the pulse width of the control signal determines the period of time that the switching stage provides voltage to the filter stage, and hence regulates the output voltage.

The fixed-switching-frequency-pulse-width-modulation (PWM) scheme has been the dominant method for controlling the switching stage. One such PWM scheme is peak-current-mode-control. This scheme uses a constant-frequency clock to turn on the switch that provides voltage to the filter stage. To turn off the switch, and thus terminate the voltage pulse to the filter stage, the scheme generates a control signal that is the integral of the difference (error) between a feedback signal and a fixed reference and compares this control signal with the peak current of the filter-stage inductor.

FIG. 1 is a schematic diagram of a switching power supply circuit 150 that employs the peak-current-mode-control approach to regulating the output voltage of a switching power supply. The switching power supply 150 provides a regulated voltage Vout at a node N6. Here, the unregulated power source 20 is a battery. The switching power supply 150 includes a regulator circuit 50 and a power supply controller 60, which includes a feedback circuit 70, an error integration circuit, often referred to as compensation circuit 80, an inductor-current comparator 90, and a PWM logic circuit and MOSFET gate driver 100, hereafter abbreviated as PWM logic.

The regulator circuit 50 includes a switching stage 30, which includes a pair of power switches T1 and T2, and a filter stage 40. The switches T1 and T2, which are N-channel MOSFETs, are connected in series between the unregulated power source 20 and the ground node NO, and are complimentarily driven with predetermined delay times to prevent a condition, often called shoot-through, where both T1 and T2 are simultaneously on. The filter circuit 40 includes an inductor L1 and a capacitor C1. L1 and C1 have respective equivalent series resistances R1 and ESR. The filter circuit 40 is connected to the switching stage 30 and generates the regulated voltage Vout on the node N6.

The feedback circuit 70 receives the regulated output voltage Vout and divides it down to a feedback voltage V_{FB} via the resistors Rₐ and R_{b}. The integrator 80 compares V_{FB} with a reference voltage V_{ref2}, which is the desired value of V_{FB}. That is, by striving to maintain V_{FB} equal to V_{ref2}, the controller 60 maintains Vout at the desired voltage level.

The integrator 80 includes an error amplifier 82 and associated capacitors C₂ and C₃, and resistor R₃, which integrate the difference, i.e., the error, between V_{ref2} and V_{FB}. The bandwidth of the integrator 80 is sufficiently lower than the switching frequency to filter the ripple component of Vout. Therefore, the output of the error amplifier 82, often referred to as control voltage Vc, is a relatively low-frequency signal that is compared to a voltage V_{iL} with a comparator 92. V_{iL} is proportional to the current i_{L} that flows through the filter-stage inductor L1.

The PWM logic 100 turns off the transistor T2 in response to a rising edge of a clock signal CLK setting an R-S flip-flop 106, and turns on the transistor T1 a predetermined time later, where the predetermined time is set by the delay circuit 108. This prevents T1 and T2 from being on simultaneously. When T1 turns on, the current i_{L} begins to increase, and thus ViL also begins to increase. When ViL exceeds Vc, the output of the comparator 92 transitions to a high logic level, and thus resets the flip-flop 106. In response to the resetting of the flip-flop 106, the PWM logic 100 turns off the transistor T1 and turns on the transistor T2, which acts as a free-wheeling diode. The PWM logic 100 then turns off the transistor T2 and turns on the transistor T1 in response to the next rising edge of CLK to repeat the cycle.

As discussed above, the method of regulation employed by the switching power supply 150 of FIG. 1 uses a fixed frequency clock signal CLK to initiate the turn-on signal, and a comparison of ViL and Vc to initiate the turn-off signal. If Vout falls below its desired level, then the feedback voltage V_{FB} falls below the reference voltage V_{ref2}, which causes the voltage Vc to rise. Therefore, an increase in Vc indicates an increase in the load on the supply 150. Because ViL must exceed Vc to turn off transistor T1 and because ViL is proportional to i_{L}, an increase in Vc causes an increase in the peak i_{L}, and thus causes an increase in current to the load. This increase in current tends to raise Vout back to its desired level. Similarly, if Vout rises above its desired level in response to a decrease in the load, then the feedback voltage V_{FB} rises above the reference voltage V_{ref2}, which causes the voltage Vc to fall. Because ViL must exceed Vc to turn off transistor T1 and because ViL is proportional to i_{L}, a decrease in Vc causes a decrease in the peak i_{L}, and thus causes a decrease in current to the load. This decrease in current tends to lower Vout back to its desired level.

Unfortunately, the power supply 150 of FIG. 1 has significant deficiencies for power management in systems such as notebook computers.

Notebook computers often require a very fast load transient response. But because the turn-on of the transistor T1 depends on the rising edge of CLK, the power supply 150 is not instantaneously responsive to transient changes in the load current. That is, if the load suddenly increases, the supply 150 cannot increase the load current until the arrival of the next rising edge of CLK.

Furthermore, high efficiency of the power supply 150 at light loads is needed to extend the life of the battery used to power notebook computers. But unfortunately, because the power supply 150 operates at a fixed frequency (the frequency of CLK), the transistor T1 is turned on at the frequency of CLK even if the load condition does not warrant the turning on of T1. Because the mere act of turning on and off T1 consumes significant power, this fixed-frequency operation significantly reduces the efficiency of the supply 150 at light loads. And even though other measures can be taken, such as skipping pulse at light loads, to improve the efficiency of the supply 150, these measures often compromise other aspects of the performance of the supply, such as the smoothness of the current transition between light and heavy loads.

### SUMMARY

In view of the foregoing, there is a need for a new and improved PWM scheme that allows switching power supplies to meet today's portable computing and communication equipment needs.

Therefore, one embodiment of the invention is a switching power supply that has (1) high light-load efficiency to extend the battery life, (2) tight regulation over the output voltage and load changes with smaller output voltage ripple, (3) a relatively constant switching frequency at heavy loads like traditional fixed switching frequency PWM supplies with clocks, and (4) fast response time to abrupt changes in the load.

In this embodiment, the power supply charges an energy storage element to generate a regulated output voltage when the output voltage has a predetermined relationship to a reference voltage, and halts the charging after a predetermined time period.

Such a power-supply circuit provides a constant voltage-second switching regulation with a feed forward function. Specifically, the control scheme reduces the switching frequency at light load conditions to reduce the switching loss of the converter and to improve the efficiency and extend the battery life. This circuit is also able to maintain a relatively constant switching frequency at heavy load conditions, the frequency being adaptive to different input voltages. This circuit also provides a more rapid response to changes in load current demand, and regulates the output voltage with relatively high accuracy and with relatively small output voltage ripple.

### BRIEF DESCRIPTION OF THE DRAWINGS

These and various other features as well as advantages of the present invention will be apparent from a reading of the following detailed description and a review of the associated drawings. Embodiments of the invention may best be understood by making reference to the following non-limiting description taken in conjunction with the accompanying drawings, in the several figures of which like referenced numerals identify like elements.

FIG. 1 is a schematic diagram of a conventional peak-current-mode switching power supply.

FIG. 2 is a schematic diagram of a switching power supply according to an embodiment of the invention.

FIGS. 3A-3E are respective timing diagrams of signals generated by the power supply of FIG. 2 according to an embodiment of the invention.

FIGS. 4A-4B are respective timing diagrams showing the regulated output voltage Vout (FIG. 4A) and the inductor current of the power supply of FIG. 2 according to an embodiment of the invention.

FIG. 5 is a schematic diagram of an electronic computer system having a switching power supply according to an embodiment of the invention.

### DETAILED DESCRIPTION

In the following detailed description of exemplary embodiments of the invention, reference is made to the accompanying drawings, which form a part hereof. The detailed description and the drawings illustrate specific exemplary embodiments by which the invention may be practiced. These embodiments are described in sufficient detail to enable those skilled in the art to practice the invention. It is understood that other embodiments may be utilized, and other changes may be made, without departing from the spirit or scope of the invention. The following detailed description is therefore not to be taken in a limiting sense.

An embodiment of the invention is a constant voltage-second (VS) switching-cycle-modulation power supply circuit with a fast transient response. This embodiment provides an accurately regulated output voltage and high light-load efficiency with small output voltage ripple. Furthermore, this power supply circuit has a relatively constant switching frequency under steady-state load conditions.

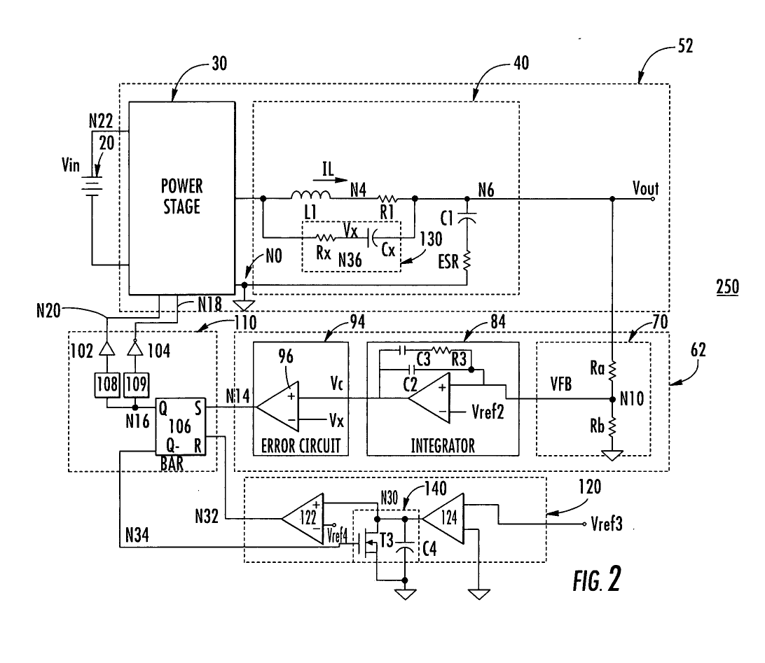

FIG. 2 is a schematic diagram of a switching power supply circuit 250 employing a constant VS switching-cycle modulation scheme according to an embodiment of the invention. The switching power supply 250 includes a regulator circuit 52, a power supply controller 62, PWM logic 110, and a pulse turn-off circuit 120. The regulator circuit 52 receives a voltage from a power source 20, such as an unregulated battery, and provides a regulated output voltage Vout on a node N6. The power supply controller 62 receives Vout from the regulating circuit 52 and provides a switch turn-on signal to PWM logic 100, which also receives a turn-off signal from the turn-off control circuit 120.

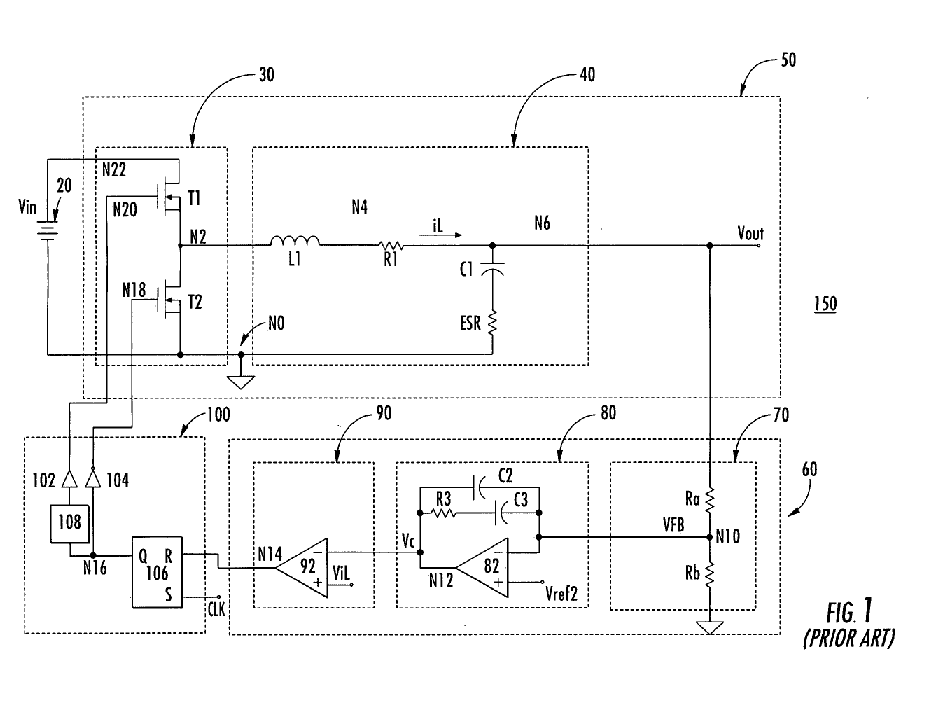

The regulator circuit 52 includes the switching stage 30 and a filter 42, which is the same as the filter 40 of FIG. 1 but for the addition of a reference-signal Vx generator 130. The switching stage 30 connects the filter circuit 42 to the power source 20. When the power source is connected to the filter circuit 42, the filter circuit absorbs a quantity of current and releases that quantity of current at a determined rate, thus, smoothing the input pulses to generate Vout at the node N6. The reference-signal generator 130 provides the reference signal Vx to the comparator 90. The signal Vx is proportional to a sum of the inductor current I_{L} and Vout.

The power supply controller 62 includes the feedback signal generator 70, an integrator circuit 84, and a turn-on circuit 94, which includes a comparator 96. The integrator circuit 84 has the same topology as the integrator 80 of FIG. 1, but may have a higher bandwidth such that the integrator does not filter out, i.e., suppress, the ripple component of Vout. As discussed above in conjunction with FIG. 1 for the integrator 80 and as discussed further below, the integrator 84 compares V_{ref2} to V_{FB}, and integrates the error between these signals to generate Vc. As V_{FB} falls below V_{ref2}, Vc rises until it is greater than Vx, at which time the comparator 96 will set the flip-flop 106, thus turning on the transistor T1 (FIG. 1). Therefore, Vc is an indication of whether Vout is within the desired regulation point. In an alternative embodiment of the invention, the feedback signal generator 70 may include a capacitor (not shown) in parallel with resistor Ra to increase the speed at which the power supply controller 62 can respond to sudden changes in the load.

The PWM logic circuit 110 receives the turn-on signal from the turn-on comparator 96 at the set (S) input of the flip-flop 106, and receives a turn-off signal from the turn-off circuit 120 at the reset (R) input of the flip-flop. The flip-flop 106 sets a logic state, here a logic 1, at its Q-output upon receiving the turn-on signal, and resets the logic state, here to a logic 0, upon receiving the turn-off signal. In addition to the delay circuit 108, the PWM logic 110 may also include a diode-emulation circuit 109, which controls the transistor T2 (FIG. 1) to prevent I_{L} from reversing (i.e., flowing into the power stage 30) at light loads.

Thus, the PWM logic 100 establishes the T1 on time between the receipt of the turn-on signal at input S and receipt of the turn-off signal at input R. During the T1-on time, the PWM logic circuit 100 issues complimentary switch-on signals from the MOSFET driver circuits represented by the non-inverting buffer 102 and the inverting buffer 104 on nodes N20 and N18 (FIG. 1), respectively, with the switch-on signal output from the non-inverting buffer 102 having a pulse width equal to the T1-on time.

In operation, the turn-on comparator 96 triggers the T1 turn-on event of the switching regulator 250. The non-inverting input of the comparator 96 receives Vc, and the inverting input of the comparator receives Vx. When Vout is lower than the desired value such that V_{FB} is lower than V_{ref2}. Vc rises and eventually exceeds Vx. This will trigger the PWM logic 100 to generate a turn-on pulse to turn on the transistor T1 (FIG. 1). Conversely, when Vout is higher than the desired value, Vc will fall below Vx, thus preventing the PWM logic 100 from generating a turn-on pulse. Therefore, the switching frequency of the supply 250 is not fixed, but is modulated by the load. As the load increases, the switching frequency increases, and as the load decreases, the switching frequency decreases. By turning on the transistor T1 in response to changes in Vout, the supply 250 can respond to changes in the load more quickly than the supply 150 of FIG. 1. Furthermore, by allowing the load to modulate the switching frequency, the supply 250 is more efficient at light loads than the supply 150.

Still referring to FIG. 2, Vx is a summation of the voltage across the capacitor Cx and Vout. When Vout decreases in response to a sudden increase in the load current, Vx will decrease accordingly. This lowers the voltage at the inverting input of the comparator 96. On the other hand, Vc, which is coupled to the non-inverting input of the comparator 96, increases. These two factors work together to generate a turn-on pulse relatively quickly in response to an increase in the load, thus further reducing the response time of the supply 250 to changes in the load. That is, the supply 250 has a fast response to dynamic loads.

Alternatively, Vx can be a fixed DC reference voltage. In such a case, the integrator 84 is the only path that can be tuned for a fast response time to changes in the load. Therefore, the integrator 84 can be designed to have a relatively high band-width so that Vc reflects sudden changes in the load current. As discussed above, this causes the integrator 84 to amplify the ripple component of Vout instead of suppressing it, and such amplification of the output ripple is contrary to the traditional design of the integrator (error-amplifier) stage.

Still referring to FIG. 2, the turn-off control circuit 120 generates a signal on the R input of the flip-flop 106 that causes the PWM logic to turn off T1 (FIG. 1) after a predetermined time. The turn-off control circuit 120 includes trans-conductance amplifier 124, a comparator 122, and a pulse-width generator circuit 140. The trans-conductance amplifier 124 receives a voltage V_{ref3} that is proportional to the input voltage Vin on the node N22. The pulse-width generator circuit 140 receives a control signal from the Q-bar output of the flip-flop 106. When this control signal equals a logic 1, it turns on the transistor T3, which discharges the capacitor C4 and holds C4 in a discharged state as long as Q-bar equals logic 1. When Q-bar transitions to a logic 0 in response to the turn on signal from the comparator 96, T3 turns off and allows the amplifier 124 to charge C4. When the voltage across C4 exceeds V_{ref4}, the output of the comparator 122 transitions to a logic 1. This logic 1 resets the flip-flop 106 and terminates the T1 turn-on pulse, thus turning off the transistor T1. Furthermore, Q-bar transitions to logic 1, thus causing T3 to discharge C4 and readying the turn-off circuit 120 for the next cycle. Effectively, the voltage across C4 is an integration of the input voltage Vin. Therefore, the voltage-second of each T1 turn-on pulse is kept substantially constant every switching cycle. An advantage of such pulse-width control is that if Vin changes, the width of the T1 turn-on pulse changes accordingly. That is, if Vin increases, the pulse width decreases, and if Vin decreases, the pulse width increases.

In summary, the above-described embodiment of the constant V-S controlled power supply 250 allows the switching frequency to change naturally with load conditions. And an accurate regulation of Vout is achieved at both light loads and heavy loads with reduced ripple, particularly when used with a capacitor C1 having a relatively small ESR.

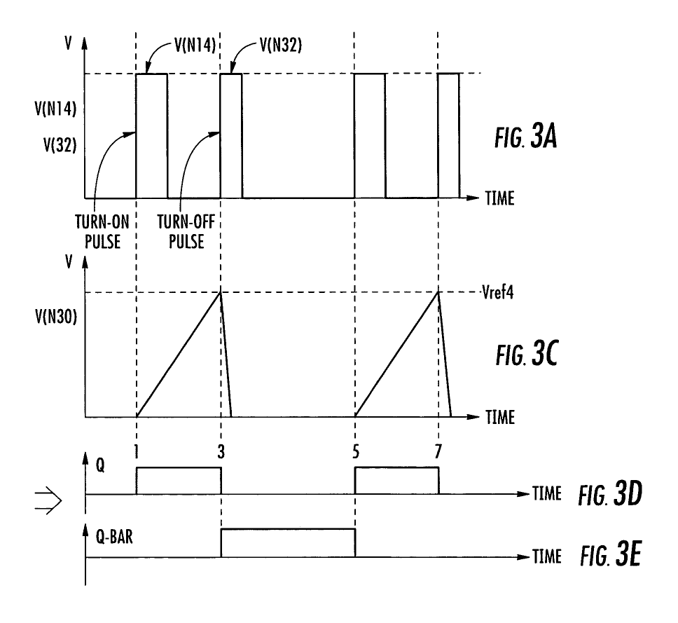

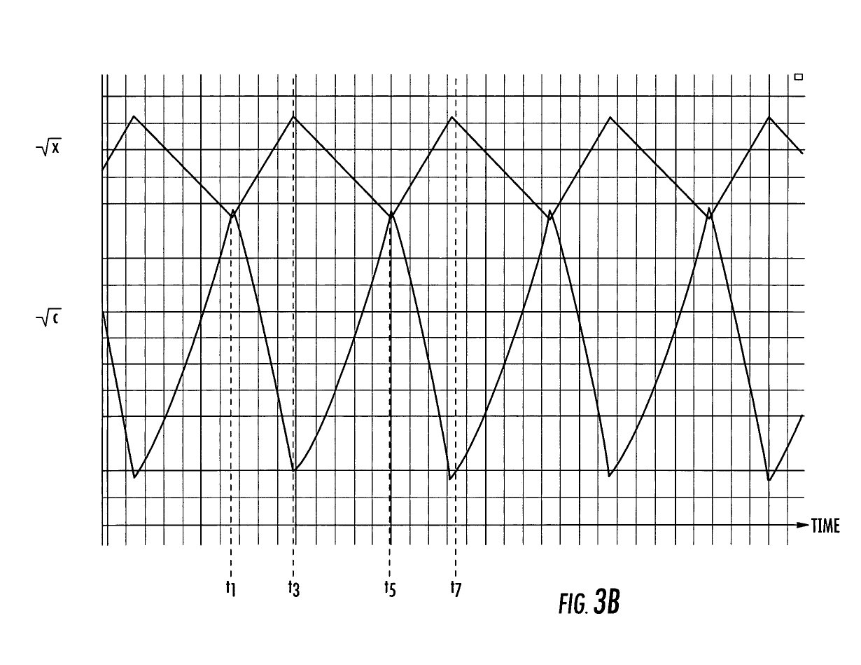

FIG. 3 illustrates the operation principle of the power supply circuit 250 of FIG. 2 according to an embodiment of the invention.

FIG. 3A shows the turn-on and turn-off signal at nodes N14 (S input of the flip-flop 106) and N32 (R input of the flip-flop 106), respectively.

FIG. 3B illustrates Vc and Vx. From time t0 to t1, Vx decreases and Vc increases due to a drop in Vout. This drop is caused by a load current reducing Vout while T1 (FIG. 1) is off. At time t1, Vc equals or exceeds Vx, thus triggering the start of the switch-on pulse. Just after time t1, Vx exceeds Vc, thus triggering the end of the switch-on pulse (T1 is still on, however, because the flip-flop 106 remains set). As Vout increases while T1 is on, Vc decreases and Vx increases until time t3, when the circuit 120 turns T1 off.

FIG. 3C illustrates the voltage waveform across C4 (at node N30), this waveform controlling the T1 turn-on pulse width (i.e., the time during which T1 is on) due to the charge rate of the capacitor C4. At time t3, the voltage at the node N30 exceeds V_{ref4}, and, thus, the turn-off pulse is issued as shown in FIG. 3A. The switch cycle from time t1 to time t5 repeats and controls the switching of the PWM logic 100.

FIG. 3D and 3E illustrate the states of Q and Q-bar of the flip-flop 106.

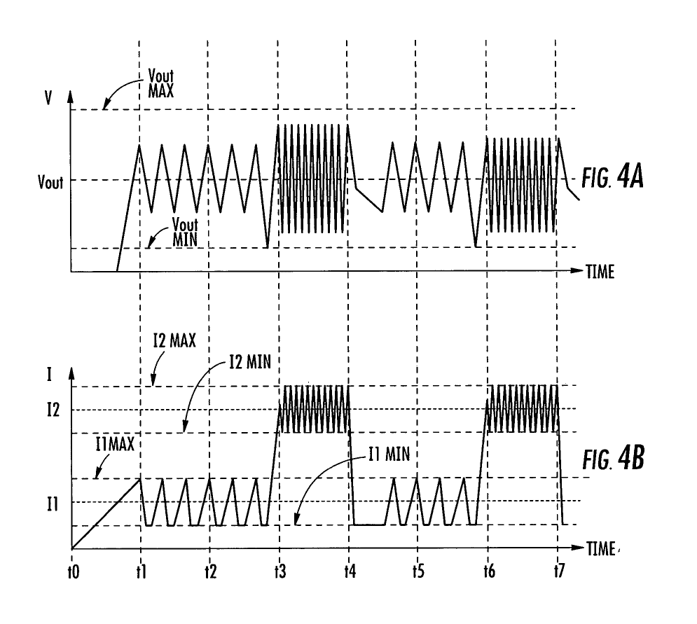

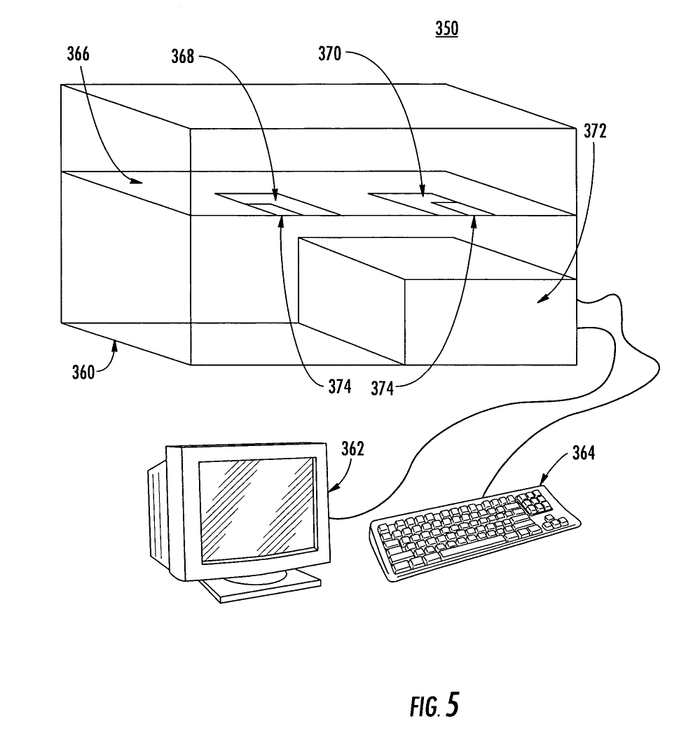

FIG. 4A shows the regulated output voltage Vout, including its ripple component, and FIG. 4B illustrates the inductor current I_{L}, under a variety of load conditions according to an embodiment of the invention where the integrator 84 (FIG. 2) amplifies the ripple component. During a start-up period between times t0 and t1, the supply 250 ramps Vout up to a desired value. Between times t1 and t2, the load current is at a steady state of I1, and so the switching frequency (which is the same as the ripple frequency) is relatively low for light load efficiency, Shortly before time t3, the load current increases suddenly from I1 to I2. This causes a dip in Vout to Voutmin, which triggers the turn-on of the transistor T1 (FIG. 2). Between times t3 and t4, the higher load current I2 causes a smooth and fast output voltage transition from light load to heavy load with increased switching frequency. At time t4, the load current suddenly decreases from I2 back to I1, which causes a smooth voltage transition from heavy load to light load with reduction in the switching frequency. Between different loading conditions, the inductor peak-to-peak voltage is about the same as the voltage-second applied to the inductor.

FIG. 5 illustrates an electronic computer system 350 having a monitor 362, a keyboard 364 and a computer 360 according to an embodiment of the invention. The computer includes a power source 372, which may be a battery or active power supply. The computer 360 also includes a circuit board 366 having integrated circuits 368 and 370. The integrated circuits may be a microprocessor, a double data rate memory, a ROM/RAM, or a hard drive. The integrated circuits 368 and 370 also each include a respective switching power supply circuit, such as the supply 250 of FIG. 2 (where the source 372 replaces the battery 20), according to an embodiment of the invention. Alternatively, one or more supplies 250 (where the source 372 replaces the battery 20) can be external to integrated circuits 368 and 370 according to an embodiment of the invention. Although the computer 360 is shown as a desktop computer, the computer may be a laptop computer.

From the foregoing it will be appreciated that, although specific embodiments of the invention have been described herein for purposes of illustration, various modifications may be made without deviating from the spirit and scope of the invention.

1. A regulator circuit comprising:
a control circuit having first and second control outputs, a turn-on input and a turn-off input, and a termination output such that the first control output is coupled to first and second control inputs of a switch circuit;
a turn-on circuit having an input coupled to receive a signal representative of a regulated output voltage of the regulator circuit and operable to generate a turn-on signal to the turn-on input of the control circuit; and
a turn-off circuit having an input coupled to receive a termination signal from the termination output of the control circuit, an input representative of a desired voltage level, and operable to generate a turn-off signal to the turn-off input of the control circuit.

2. The regulator of claim 1, further comprising a filter circuit having a first voltage reference circuit for providing a first reference voltage.

3. The regulator of claim 1, wherein the turn-on circuit further comprises a feedback signal generator operable to provide a feedback signal.

4. The regulator of claim 1, wherein the turn-on circuit further comprises an integrator circuit operable to amplify a ripple component of the regulated output voltage.

5. The regulator of claim 1, wherein the turn-on circuit further comprises a comparator generating the turn-on signal from a comparison of the desired voltage level and a signal representative of the feedback signal.

6. The regulator of claim 1, wherein the turn-off circuit further comprises a comparator coupled to voltage storage device and operable to discharge at a predetermined rate such that the turn-off signal is generated.

7. A power-supply circuit, comprising:
an output node operable to provide a regulated supply voltage;
a switching circuit operable to generate the regulated supply voltage by coupling an input voltage to the output node while active and uncoupling the input voltage from the output node while inactive;
a feedback circuit coupled to the output node and operable to generate a feedback signal from the regulated supply voltage, to generate a first comparison signal from the feedback signal, and to generate a second comparison signal from the first comparison signal; and
a switching-control circuit coupled to the switching and feedback circuits and operable to activate the switching circuit in response to the second comparison signal and to inactivate the switching circuit a predetermined time after activating the switching circuit.

8. The power-supply circuit of claim 7 wherein the switching circuit further comprises first and second transistors, the first transistor operable to couple the input voltage to a filter circuit while the second transistor is off and the second transistor operable to couple the filter circuit to ground while the first transistor is off.

9. The power-supply circuit of claim 7 wherein the switching circuit further comprises a filter circuit operable to receive the input voltage and store a quantity of current.

10. The power-supply circuit of claim 7 wherein the switching circuit further comprises a reference signal generator operable to generate a first reference signal.

11. The power-supply circuit of claim 7 wherein the feedback circuit further comprises a reference generator operable to form the feedback signal.

12. The power-supply circuit of claim 7 wherein the feedback circuit further comprises an integrator circuit operable to generate the first comparison signal from a comparison of the feedback signal and a first voltage reference.

13. The power-supply circuit of claim 7 wherein the feedback circuit further comprises an error circuit operable to generate the second comparison signal from a comparison of the first comparison signal and a second voltage reference.

14. The power-supply circuit of claim 7 wherein the switching-control circuit further comprises a logic storage device operable to generate first and second logic signals and a control signal, and coupled to receive the second comparison signal.

15. The power-supply circuit of claim 7 further comprises a turn-off control circuit operable to generate a turn-off control signal and coupled to receive a termination control signal of the switching-control circuit and a third reference voltage.

16. The power-supply circuit of claim 7 further comprises a turn-off control circuit operable to generate a turn-off control signal from a first comparison of a fourth reference voltage to a stored voltage generated where the stored voltage is determined by a second comparison of a third reference voltage.

17. An electronic system having an integrated circuit receiving a power source comprising:
a control circuit having first and second control outputs, a turn-on input and a turn-off input, and a termination output such that the first control output is coupled to first and second control inputs of a switch circuit;
a turn-on circuit having an input coupled to receive a signal representative of a regulated output voltage of the regulator circuit and operable to generate a turn-on signal to the turn-on input of the control circuit; and
a turn-off circuit having an input coupled to receive a termination signal from the termination output of the control circuit, an input representative of a desired voltage level, and operable to generate a turn-off signal to the turn-off input of the control circuit.

18. The electronic system of claim 17, wherein the power source is a battery or an unregulated power supply.

19. The electronic system of claim 17, wherein the integrated circuit includes a CPU, a RAM, Double Data Rate Memory or a hard disk.

20. The electronic system of claim 17, wherein the electronic system includes a switching circuit.

21. The electronic system of claim 17, wherein the electronic system further includes a filter circuit coupled to provide a regulated voltage to the integrated circuit.

22. A method, comprising:
charging an energy-storage element to generate a regulated output voltage when the output voltage has a predetermined relationship to a reference voltage; and
halting the charging after a predetermined time period.

23. The method of claim 22 wherein charging the energy-storage element comprises coupling the energy-storage element to a power source.

24. The method of claim 22 wherein:
charging the energy-storage element comprises coupling the energy-storage element to a power source; and
halting the charging comprises uncoupling the energy-storage element from the power source.

25. The method of claim 22 wherein charging the energy-storage element includes generating a turn-on signal.

26. The method of claim 22 wherein the halting of the charging includes generating a turn-off signal.
